(19) United States
(12) Patent Application Publication
(10) Pub. No.: US 2013/0047420 A1
(43) Pub. Date: Feb. 28, 2013

(54) METHOD FOR MANUFACTURING TOUCH PANEL

(71) Applicants: Seung Hyun Ra, Gyunggi-do (KR); Sang Su Hong, Gyunggi-do (KR)

(72) Inventors: Seung Hyun Ra, Gyunggi-do (KR); Sang Su Hong, Gyunggi-do (KR)

(73) Assignee: SAMSUNG ELECTRO-MECHANICS CO., LTD., Gyunggi-do (KR)

(21) Appl. No.: 13/328,236

(22) Filed: Dec. 16, 2011

(30) Foreign Application Priority Data
Aug. 29, 2011 (KR) 1020110086612

(51) Int. Cl. H01H 65/00

(52) U.S. Cl. 29/622

(57) ABSTRACT

Disclosed herein is a method for manufacturing a touch panel, the method including: (A) applying a barrier layer to a transparent substrate; (B) patterning the bather layer using a stamp so that open parts are formed in the barrier layer; and (C) forming sensing electrodes in the open parts, the sensing electrode being made of a metal. The bather layer is patterned using the stamp and the sensing electrodes are then formed in the open parts of the barrier layer, thereby making it possible to simplify a manufacturing process as compared to a photolithography process and to reduce a manufacturing cost.

### CROSS REFERENCE TO RELATED APPLICATION

This application claims the benefit of Korean Patent Application No. 10-2011-0086612, filed on Aug. 29, 2011, entitled “Method for Manufacturing Touch Panel”, which is hereby incorporated by reference in its entirety into this application.

### BACKGROUND OF THE INVENTION

1. Technical Field

The present invention relates to a method for manufacturing a touch panel.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

While the rapid advancement of an information-oriented society has been widening the use of computers more and more, it is difficult to efficiently operate products using only a keyboard and mouse currently serving as an input device. Therefore, the necessity for a device that is simple, has minimum malfunction, and is capable of easily inputting information has increased.

In addition, current techniques for input devices have progressed toward techniques related to high reliability, durability, innovation, designing and processing beyond the level of satisfying general functions. To this end, a touch panel has been developed as an input device capable of inputting information such as text, graphics, or the like.

This touch panel is mounted on a display surface of an image display device such as an electronic organizer, a flat panel display device including a liquid crystal display (LCD) device, a plasma display panel (PDP), an electroluminescence (El) element, or the like, or a cathode ray tube (CRT) to thereby be used to allow a user to select desired information while viewing the image display device.

Meanwhile, the touch panel is classified into a resistive type touch panel, a capacitive type touch panel, an electromagnetic type touch panel, a surface acoustic wave (SAW) type touch panel, and an infrared type touch panel. These various types of touch panels are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch panel and the capacitive type touch panel have been prominently used in a wide range of fields.

In this touch panel, a sensing electrode is generally made of indium tin oxide (ITO). However, the ITO has excellent electrical conductivity but is expensive since indium used as a raw material thereof is a rare earth metal. In addition, the indium is expected to be depleted within the next decade, such that it may not be smoothly supplied.

For this reason, research into a technology of using a metal as a material of a sensing electrode has been actively conducted. When the sensing electrode is made of a metal, it is advantageous in that the metal has much more excellent electric conductivity as compared to the ITO and may be smoothly supplied. However, in the case of the method for manufacturing a touch panel according to the prior art, a sensing electrode is formed by a photolithography process, which makes a manufacturing process complicated and makes a manufacturing cost expensive. In addition, when the sensing electrode is formed by the photolithography process, it is protruded from a transparent substrate, such that it is structurally weakened.

### SUMMARY OF THE INVENTION

The present invention has been made in an effort to provide a method for manufacturing a touch panel capable of simplifying a manufacturing process and reducing a manufacturing cost by patterning a barrier layer using a stamp and then forming sensing electrodes.

According to a first preferred embodiment of the present invention, there is provided a method for manufacturing a touch panel, the method including: (A) applying a barrier layer to a transparent substrate; (B) patterning the barrier layer using a stamp so that open parts are formed in the bather layer; and (C) forming sensing electrodes in the open parts, the sensing electrode being made of a metal.

At step (C), the sensing electrodes may be formed by a deposition process, a plating process, or an inkjet printing process.

The method may further include, after step (C), removing the barrier layer.

The barrier layer may be made of a thermosetting resin or a photocurable resin.

The method may further include, after step (B), curing the bather layer.

At step (B), residues of the barrier layer may remain in the open parts.

At step (C), electrode wirings may be formed in the open parts simultaneously with forming the sensing electrodes, the electrode wirings being made of a metal and connected to the sensing electrodes.

At step (B), the stamp may have a flat shape or a circular shape. According to a second preferred embodiment of the present invention, there is provided a method for manufacturing a touch panel, the method including: (A) applying a barrier layer to a transparent substrate; (B) patterning the barrier layer and the transparent substrate using a stamp so that open parts are formed in the barrier layer and depressed concave parts corresponding to the open parts are formed in the transparent substrate; and (C) forming sensing electrodes in the concave parts, the sensing electrode being made of a metal.

At step (C), the sensing electrodes may be formed by a deposition process, a plating process, or an inkjet printing process.

The method may further include, after step (C), removing the bather layer.

The barrier layer may be made of a thermosetting resin or a photocurable resin.

The method may further include, after step (B), curing the bather layer.

At step (B), residues of the barrier layer may remain in the concave parts.

At step (C), electrode wirings may be formed in the concave parts simultaneously with forming the sensing electrodes, the electrode wirings being made of a metal and connected to the sensing electrodes.

At step (B), the stamp may have a flat shape or a circular shape.

At step (C), the sensing electrodes may be formed so as to be buried in the concave parts.

### BRIEF DESCRIPTION OF THE DRAWINGS

FIGS. 1, 2, 3A, 3B, 4A, 4B, 5, 6A, and 6B are cross-sectional views showing a method for manufacturing a touch panel according to a first preferred embodiment of the present invention in a process sequence;

FIGS. 7, 8, 9A, 9B, 10A, 10B, 11, 12A, and 12B are cross-sectional views showing a method for manufacturing a touch panel according to a second preferred embodiment of the present invention in a process sequence;

FIG. 13 is a plan view of the touch panel according to the first and second preferred embodiments of the present invention; and

FIGS. 14A, 15A, and 16A are cross-sectional views of the touch panel manufactured according to the first preferred embodiment of the present invention; and FIGS. 14B, 15B, and 16B are cross-sectional views of the touch panel manufactured according to the second preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, in describing the present invention, a detailed description of related known functions or configurations will be omitted so as not to obscure the subject of the present invention.

Hereinafter, preferred embodiments of the present invention will be described in detail with reference to the accompanying drawings.

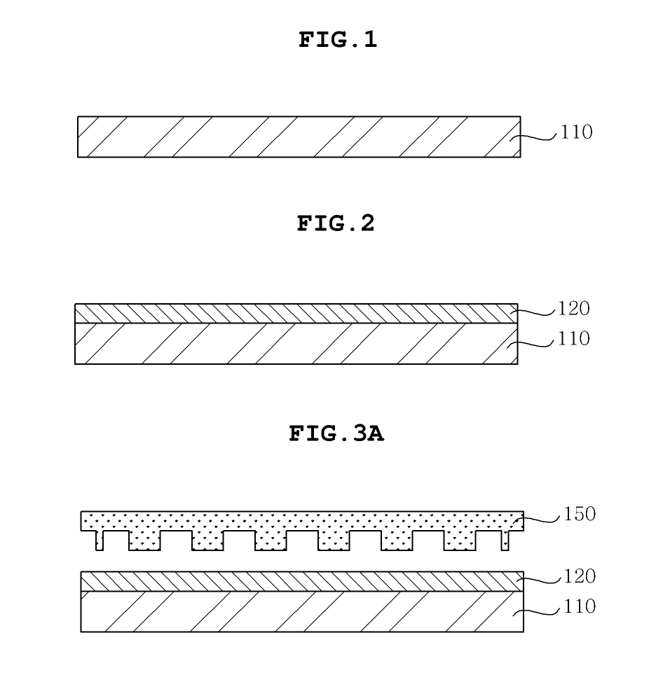

FIGS. 1 to 6 are cross-sectional views showing a method for manufacturing a touch panel according to a first preferred embodiment of the present invention in a process sequence.

As shown in FIGS. 1 to 6, a method for manufacturing a touch panel according to the present embodiment is configured to include (A) applying a barrier layer 120 to a transparent substrate 110, (B) patterning the bather layer 120 using a stamp 150 so that open parts 125 are formed in the barrier layer 120, and (C) forming sensing electrodes 130 in the open parts 125, the sensing electrode being made of a metal.

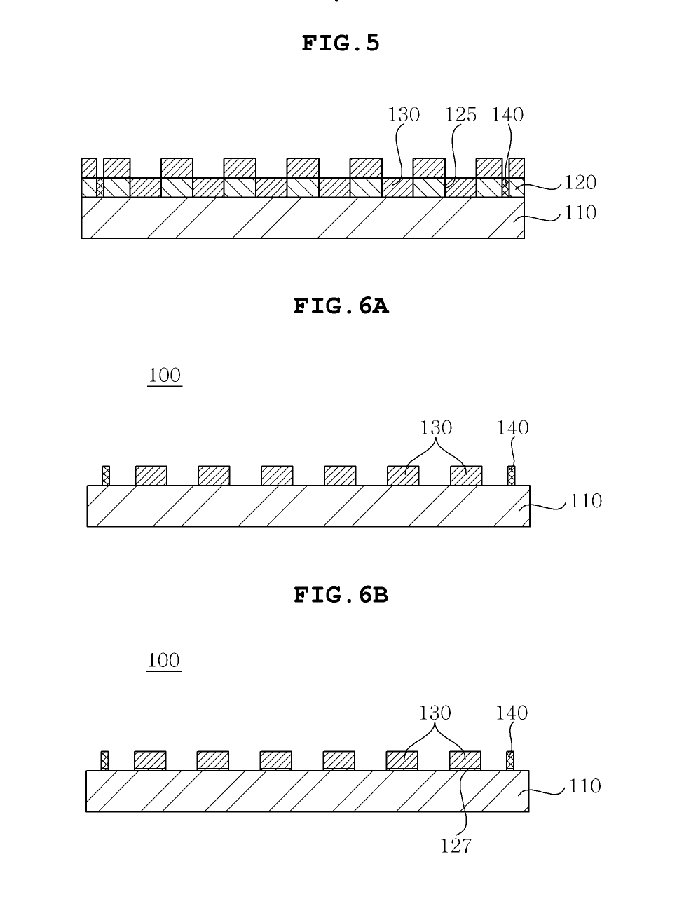

First, as shown in FIG. 1, an operation of preparing the transparent substrate 110 is performed. Here, the transparent substrate 110 serves to provide areas at which the sensing electrodes 130 and electrode wirings 140 are to be formed (See FIG. 5). Therefore, the transparent substrate 110 needs to have support force capable of supporting the sensing electrodes 130 and the electrode wirings 140 and transparency capable of allowing a user to recognize an image provided by an image display device. In consideration of the support force and the transparency described above, the transparent substrate 110 may be made of polyethylene terephthalate (PET), polycarbonate (PC), poly methyl methacrylate (PMMA), polyethylene naphthalate (PEN), polyethersulpon (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing a K resin), glass, or tempered glass, but is not necessarily limited thereto.

Next, as shown in FIG. 2, an operation of applying the barrier layer 120 to the transparent substrate 110 is performed. Here, as a material of the barrier layer 120, a thermosetting resin or a photocurable resin (a dry film, a liquid photoresist) may be used. Here, the reason for using the thermosetting resin or the photocurable resin as a material of the barrier layer 120 is to pattern the barrier layer 120 and then cure the barrier layer 120 by heat or light (ultraviolet rays). A specific curing process will be described below.

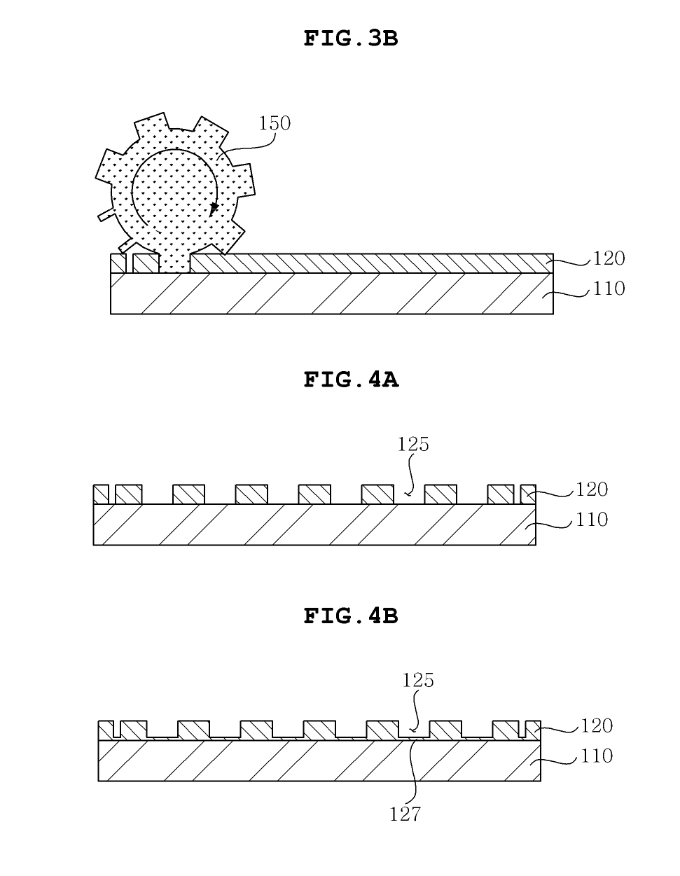

Then, as shown in FIGS. 3 and 4, an operation of patterning the barrier layer 120 using the stamp 150 so that the open parts 125 are formed in the bather layer 120 is performed. Here, the open parts 125 are formed by allowing the stamp 150 to penetrate through the bather layer 120 in a thickness direction. The barrier layer 120 may be completely removed in the open parts 125 (See FIG. 4A); however, residues 127 of the barrier layer 120 may remain in the open parts 125 as needed (See FIG. 4B). The sensing electrodes 130 and the electrode wirings 140 are to be formed in the open parts 125 in an operation to be described below. Therefore, it is preferable that the barrier layer 120 is patterned using the stamp 150 in consideration of the patterns of the sensing electrodes 130 and the electrode wirings 140. Here, the stamp 150 is not particularly limited as long as it is embossed, but the stamp may have a flat shape (See FIG. 3A) or a circular shape (See FIG. 3B). Among others, when the circular stamp 150 is used, a continuous process may be performed by applying a roll to roll process.

After the barrier layer 120 is patterned using the stamp 150, the barrier layer 120 is cured. Here, the barrier layer 120 may be cured using heat or light (ultraviolet rays) according to a material thereof More specifically, when a thermosetting resin is used as a material of the bather layer 120, the barrier layer 120 is cured using heat. When a photocurable resin is used as a material of the barrier layer 120, the barrier layer 120 is cured using light (ultraviolet rays).

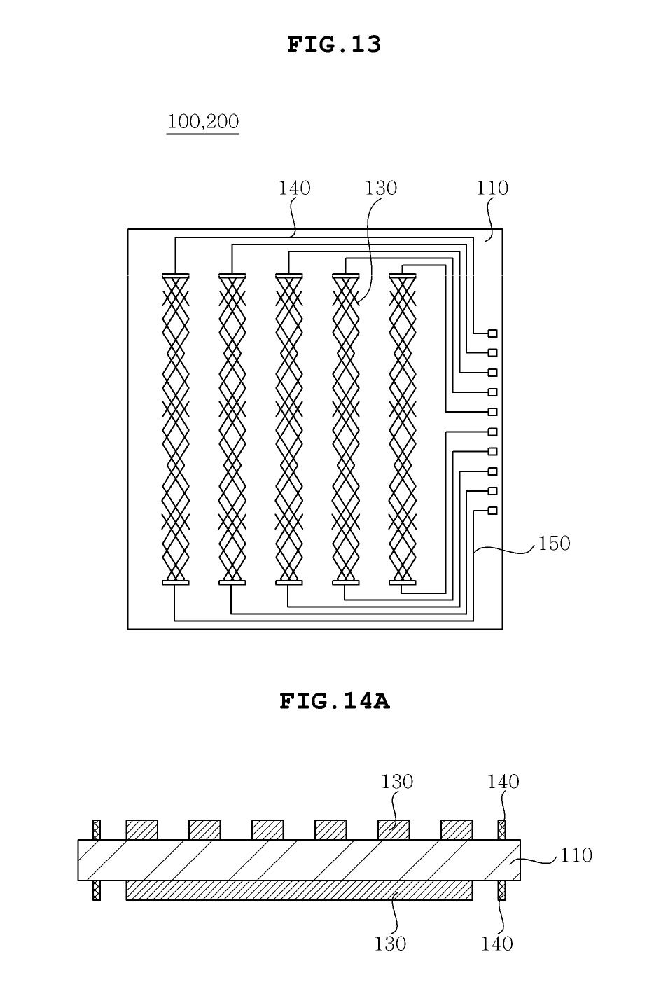

Then, as shown in FIG. 5, an operation of forming the sensing electrodes 130 in the open parts 125 is performed, the sensing electrode being made of a metal. Here, the sensing electrodes 130 may be formed by a deposition process such as, for example, sputtering, E-beam evaporation, or the like. However, the sensing electrodes 130 are not necessarily formed by the deposition process but may also be formed by a plating process, an inkjet printing process, or the like. When the sensing electrodes 130 are formed by a plating process, the sensing electrodes 130 may be formed by forming a seed layer through electroless plating and then performing electroplating on the seed layer using a lead wire. Meanwhile, as a metal configuring the sensing electrode 130, copper (Cu), aluminum (Al), gold (Au), silver (Ag), titanium (Ti), palladium (Pd), chrome (Cr), or a combination thereof may be used. Among others, when the sensing electrode 130 is made of copper (Cu), black oxide may be performed on a surface of the sensing electrode 130. The black oxide means a process of oxidizing the surface of the sensing electrode 130 to thereby precipitate Cu₂O or CuO. The surface of the sensing electrode 130 is subjected to the black oxide, thereby making it possible to prevent light from being reflected on the sensing electrode 130 and thus to improve visibility of the touch panel 100. However, the sensing electrode 130 is not limited to being made of the above-mentioned metals but may be made of all metals that have high electric conductivity and are easily processed. Further, since the sensing electrode 130 is made of a metal, the sensing electrode 130 may be formed in a mesh pattern in order to prevent a problem from being generated due to transparency of the touch panel 100 caused by characteristics of an opaque metal (See FIG. 13).

Meanwhile, the electrode wirings 140 may be formed in the open parts 125 simultaneously with forming the sensing electrodes 130, the electrode wirings being made of a metal. Here, the electrode wirings 140, which are connected to the sensing electrodes 130, are formed integrally with the sensing electrodes 130, thereby making it possible to simplify a manufacturing process of the touch panel 100 and to reduce a lead time. Furthermore, since the sensing electrodes 130 and the electrode wirings 140 are simultaneously formed, a bonding process between the electrode wirings 140 and the sensing electrodes 130 may be omitted. Therefore, it is possible to previously prevent steps or bonding defects between the sensing electrodes 130 and the electrode wirings 140 from being generated.

Then, as shown in FIG. 6, an operation of removing the barrier layer 120 is performed. Since the sensing electrodes 130 were formed in the above-mentioned operation, the barrier layer 120 has completed its role. Therefore, the barrier layer 120 is removed in the present operation. Here, the barrier layer 120 may be removed using a stripping solution such as NaOH, KOH, or the like. The barrier layer 120 is removed as described above, such that the manufacturing of the touch panel 100 is completed.

Meanwhile, when the residues 127 of the barrier layer 120 remain in the open parts 125 (See FIG. 4), the residues 127 of the bather layer 120 may finally remain between the sensing electrodes 130 and the transparent substrate 110, as shown in FIG. 6B.

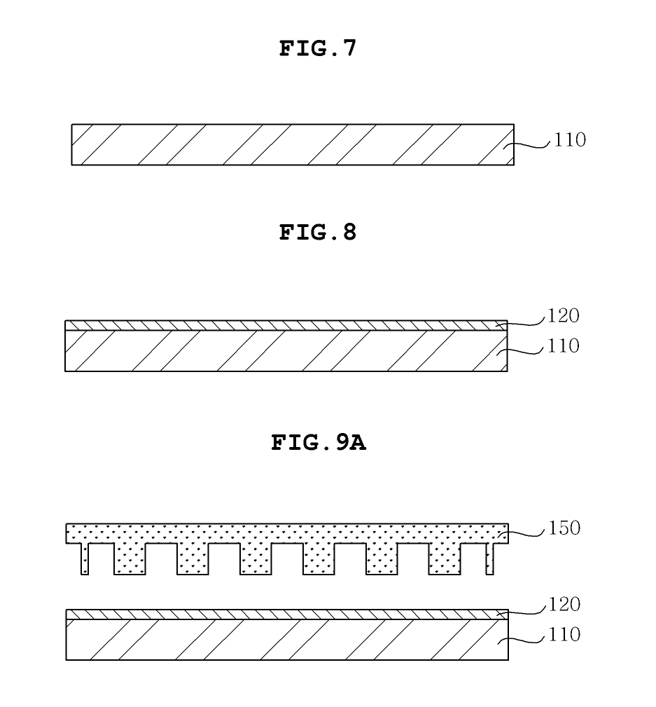

FIGS. 7 to 12 are cross-sectional views showing a method for manufacturing a touch panel according to a second preferred embodiment of the present invention in a process sequence.

As shown in FIGS. 7 to 12, a method for manufacturing a touch panel according to the present embodiment is configured to include (A) applying a barrier layer 120 to a transparent substrate 110, (B) patterning the bather layer 120 and the transparent substrate 110 using a stamp 150 so that open parts 125 are formed in the bather layer 120 and depressed concave parts 115 corresponding to the open parts 125 are formed in the transparent substrate 110, and (C) forming sensing electrodes 130 in the concave parts 115, the sensing electrode being made of a metal.

The greatest difference between the touch panel 100 according to the first preferred embodiment of the present invention described above and the touch panel 200 according to the second preferred embodiment of the present invention is whether or not the concave parts 115 are formed in the transparent substrate 110. Therefore, in the touch panel 200 according to the second preferred embodiment of the present invention, the concave parts 115 formed in the transparent substrate 110 will be mainly described. In addition, a description of contents overlapped with those of the touch panel 100 according to the first preferred embodiment of the present invention will be omitted.

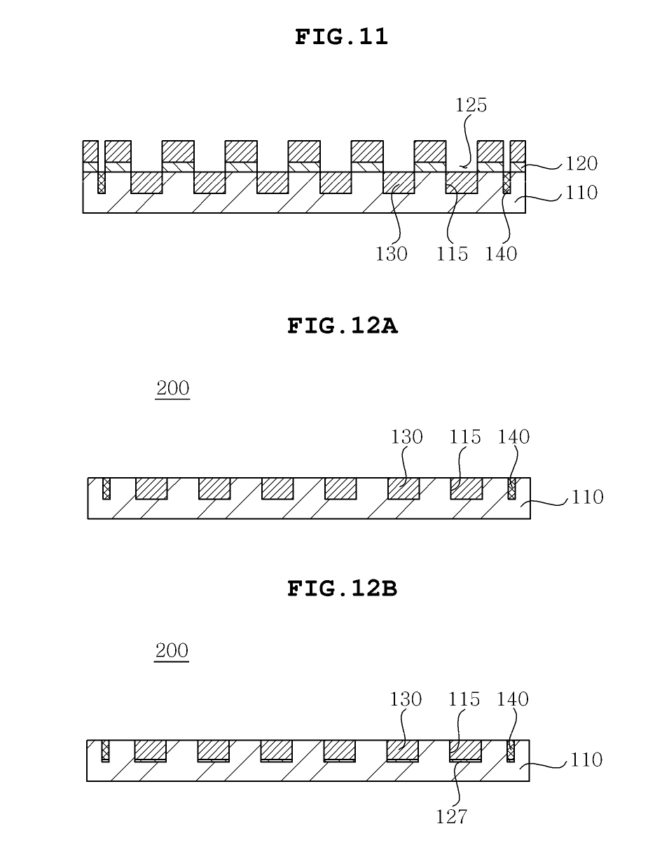

First, as shown in FIG. 7, an operation of preparing the transparent substrate 110 is performed. Here, the transparent substrate 110 serves to provide areas at which the sensing electrodes 130 and electrode wirings 140 are to be formed (See FIG. 11).

Next, as shown in FIG. 8, an operation of applying the barrier layer 120 to the transparent substrate 110 is performed. Here, as a material of the barrier layer 120, a thermosetting resin or a photocurable resin (a dry film, a liquid photoresist) may be used.

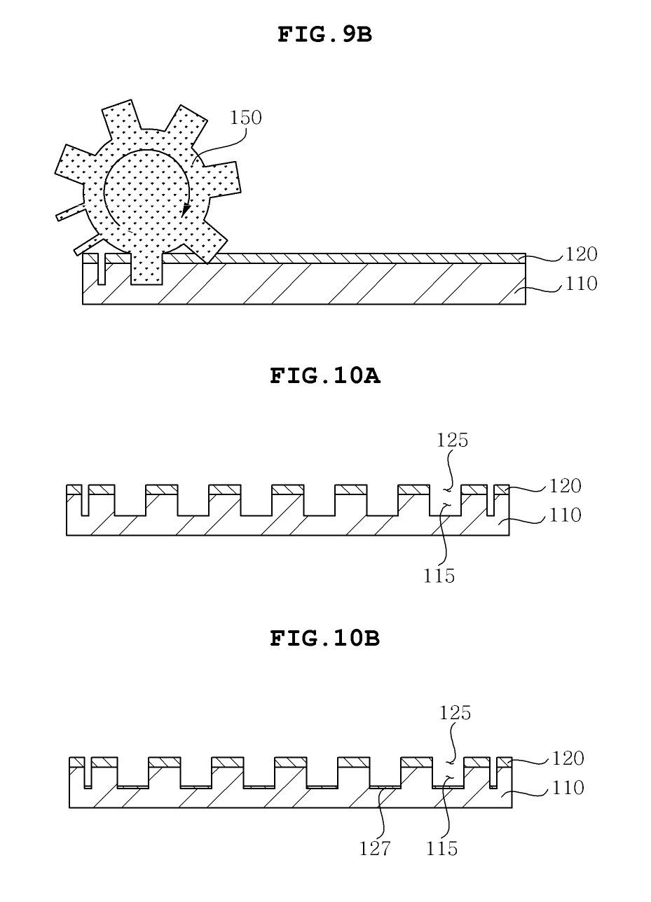

Then, as shown in FIGS. 9 and 10, an operation of patterning the barrier layer 120 and the transparent substrate 110 using a stamp 150 so that the open parts 125 are formed in the barrier layer 120 and the depressed concave parts 115 corresponding to the open parts 125 are formed in the transparent substrate 110 is performed. Here, the open parts 125 are formed by allowing the stamp 150 to penetrate through the barrier layer 120 in a thickness direction, and the concave parts 115 are formed by depressing the transparent substrate 110 by a predetermined depth in the thickness direction using the stamp 150 penetrating through the open parts 125. Here, the barrier layer 120 may be completely removed in the open parts 125 and the concave parts 115 (See FIG. 10A); however, residues 127 of the barrier layer 120 may remain in the concave parts 115 as needed (See FIG. 10B) The sensing electrodes 130 and the electrode wirings 140 are to be formed in the concave parts 115 in an operation to be described below. Therefore, it is preferable that the barrier layer 120 and the transparent substrate 110 are patterned using the stamp 150 in consideration of the patterns of the sensing electrodes 130 and the electrode wirings 140. Here, the stamp 150 is not particularly limited as long as it is embossed, but may have a flat shape (See FIG. 9A) or a circular shape (See FIG. 9B).

After the barrier layer 120 is patterned using the stamp 150, the barrier layer 120 is cured. Here, the bather layer 120 may be cured using heat or light (ultraviolet rays) according to a material thereof.

Then, as shown in FIG. 11, an operation of forming the sensing electrodes 130 in the concave portions 115 is performed, the sensing electrode being made of a metal. Here, the sensing electrodes 130 may also be formed by a deposition process such as, for example, sputtering, E-beam evaporation, or the like, a plating process, an inkjet printing process, or the like. In addition, as a metal configuring the sensing electrode 130, copper (Cu), aluminum (Al), gold (Au), silver (Ag), titanium (Ti), palladium (Pd), chrome (Cr), or a combination thereof may be used. Further, since the sensing electrode 130 is made of a metal, the sensing electrode 130 may be formed in a mesh pattern in order to prevent a problem from being generated due to transparency of the touch panel 200 caused by characteristics of an opaque metal (See FIG. 13).

Meanwhile, the electrode wirings 140 may be formed in the concave parts 115 simultaneously with forming the sensing electrodes 130, the electrode wirings being made of a metal. Here, the electrode wirings 140, which are connected to the sensing electrodes 130, are formed integrally with the sensing electrodes 130, thereby making it possible to simplify a manufacturing process of the touch panel 200 and to reduce a lead time. Furthermore, since the sensing electrodes 130 and the electrode wirings 140 are simultaneously formed, a bonding process between the electrode wirings 140 and the sensing electrodes 130 may be omitted. Therefore, it is possible to previously prevent steps or bonding defects between the sensing electrodes 130 and the electrode wirings 140 from being generated.

Then, as shown in FIG. 12, an operation of removing the barrier layer 120 is performed. Since the sensing electrodes 130 were formed in the above-mentioned operation, the barrier layer 120 has completed its role. Therefore, the barrier layer 120 is removed in the present operation. Here, the bather layer 120 may be removed using a stripping solution such as NaOH, KOH, or the like. The barrier layer 120 is removed as described above, such that the manufacturing of the touch panel 200 is completed.

Meanwhile, as shown in FIG. 12A, since the sensing electrodes 130 are formed in the depressed concave parts 115, the sensing electrodes 130 are finally formed to be buried in the concave parts 115. As a result, a bottom surface and sides of the sensing electrode 130 contact the concave portion 115, thereby making it possible to secure structural reliability of the sensing electrode 130. In addition, even though the residues 127 of the barrier layer 120 remain in the concave parts 115 (See FIG. 10B), sides of the sensing electrode 130 contact the concave part 115 as shown in FIG. 12B, thereby making it possible to prevent the sensing electrode 130 from being separated from the transparent substrate 110.

FIG. 13 is a plan view of the touch panel according to the first and second preferred embodiments of the present invention.

As shown in FIG. 13, the touch panel 100 or 200 according to the present invention is configured to include the transparent substrate 110, the sensing electrodes 130, and the electrode wirings 140. Here, the sensing electrode 130 serves to generate a signal when being touched by an input unit to thereby allow a controller to recognize touched coordinates, and the electrode wiring 140 is connected to the sensing electrode 130 to thereby serve to receive an electrical signal from the sensing electrode 130 and transfer the received electrical signal to the controller. As described above, the touch panel 100 or 200 according to the present invention may be used as a self capacitive type touch panel or a mutual capacitive type touch panel by using the sensing electrodes 130 having a single layer structure. However, the touch panel according to the present invention is not limited thereto but may be manufactured in various types having the configurations as described below.

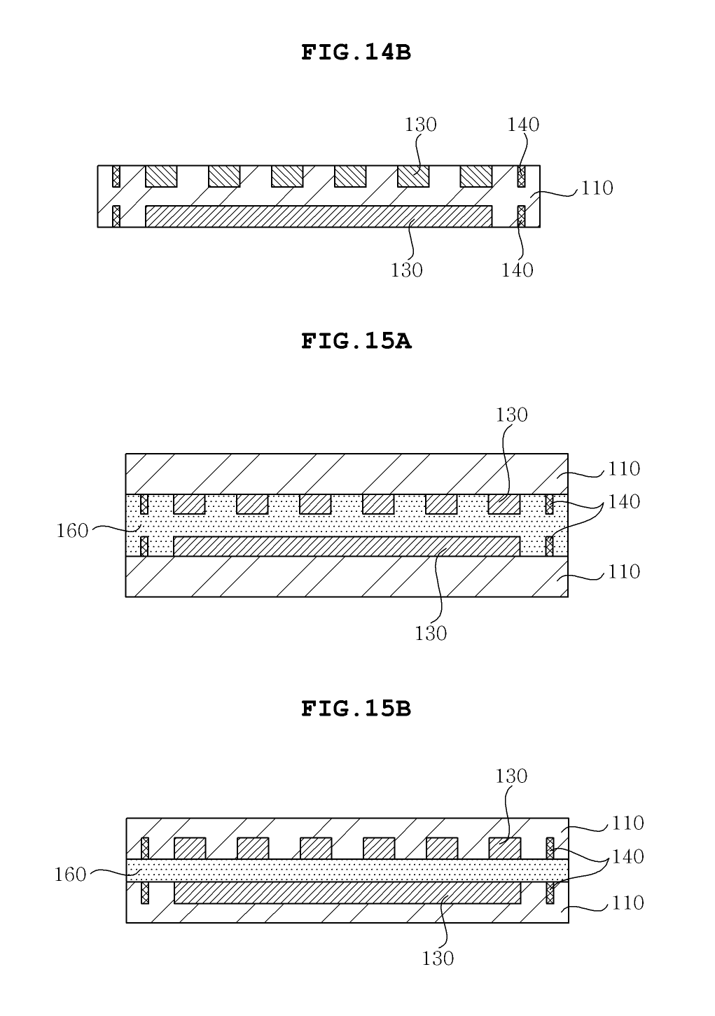

FIGS. 14A, 15A, and 16A are cross-sectional views of the touch panel manufactured according to the first preferred embodiment of the present invention; and FIGS. 14B, 15B, and 16B are cross-sectional views of the touch panel manufactured according to the second preferred embodiment of the present invention.

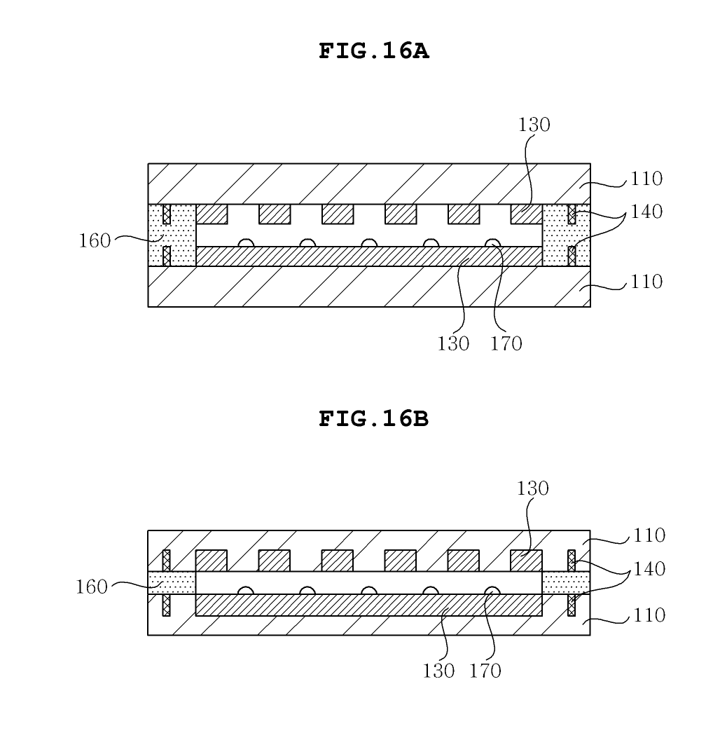

As shown in FIGS. 14A and 14B, a mutual capacitive touch panel (See FIG. 13) may be manufactured by forming the sensing electrodes 130 on both surfaces of the transparent substrate 110, respectively. In addition, as shown in FIGS. 15 and 16, a mutual capacitive type touch panel (See FIGS. 15A and 15B) or a resistive type touch panel (See FIGS. 16A and 16B) may be manufactured by preparing two transparent substrates 110 including the sensing electrodes 130 formed on one surface thereof and bonding the two sensing substrates 110 to each other using an adhesive layer 160 so that the sensing electrodes 130 face each other. Here, in the case of the mutual capacitive type touch panel (See FIGS. 15A and 15B), the adhesive layer 160 is bonded over the entire surface of the transparent electrode 110 so that the two facing sensing electrodes 130 are insulated from each other. Meanwhile, in the case of the resistive type touch panel (See FIGS. 16A and 16B), the adhesive layer 160 is bonded only to the edge of the transparent substrate 110 so that the two facing sensing electrodes 130 are in contact with each other when pressure of an input unit is operated and dot spacers 170 are provided on the exposed surfaces of the sensing electrode 130, the dot spacer providing repulsive force so that the sensing electrode 130 is returned to its original position when the pressure of the input unit is removed.

According to the preferred embodiments of the present invention, the barrier layer is patterned using the stamp and the sensing electrodes are then formed in the open parts of the bather layer, thereby making it possible to simplify a manufacturing process as compared to a photolithography process and to reduce a manufacturing cost.

In addition, according to the preferred embodiments of the present invention, the depressed concave parts are formed in the transparent substrate using the stamp and the sensing electrodes are then formed in the concave parts, thereby making it possible to bury the sensing electrodes in the concave parts. Therefore, it is possible to secure structural reliability of the sensing electrodes.

Although the preferred embodiments of the present invention have been disclosed for illustrative purposes, they are for specifically explaining the present invention and thus a method for manufacturing a touch panel according to the present invention is not limited thereto, but those skilled in the art will appreciate that various modifications, additions and substitutions are possible, without departing from the scope and spirit of the invention as disclosed in the accompanying claims. Accordingly, any and all modifications, variations or equivalent arrangements should be considered to be within the scope of the invention, and the detailed scope of the invention will be disclosed by the accompanying claims.

What is claimed is:

1. A method for manufacturing a touch panel, the method comprising:
(A) applying a barrier layer to a transparent substrate;
(B) patterning the barrier layer using a stamp so that open parts are formed in the barrier layer; and
(C) forming sensing electrodes in the open parts, the sensing electrode being made of a metal.

2. The method as set forth in claim 1, wherein at step (C), the sensing electrodes are formed by a deposition process, a plating process, or an inkjet printing process.

3. The method as set forth in claim 1, further comprising, after step (C), removing the barrier layer.

4. The method as set forth in claim 1, wherein the barrier layer is made of a thermosetting resin or a photocurable resin.

5. The method as set forth in claim 1, further comprising, after step (B), curing the barrier layer.

6. The method as set forth in claim 1, wherein at step (B), residues of the bather layer remain in the open parts.

7. The method as set forth in claim 1, wherein at step (C), electrode wirings are formed in the open parts simultaneously with forming the sensing electrodes, the electrode wirings being made of a metal and connected to the sensing electrodes.

8. The method as set forth in claim 1, wherein at step (B), the stamp has a flat shape or a circular shape.

9. A method for manufacturing a touch panel, the method comprising:
(A) applying a barrier layer to a transparent substrate;
(B) patterning the barrier layer and the transparent substrate using a stamp so that open parts are formed in the barrier layer and depressed concave parts corresponding to the open parts are formed in the transparent substrate; and
(C) forming sensing electrodes in the concave parts, the sensing electrode being made of a metal.

10. The method as set forth in claim 9, wherein at step (C), the sensing electrodes are formed by a deposition process, a plating process, or an inkjet printing process.

11. The method as set forth in claim 9, further comprising, after step (C), removing the barrier layer.

12. The method as set forth in claim 9, wherein the barrier layer is made of a thermosetting resin or a photocurable resin.

13. The method as set forth in claim 9, further comprising, after step (B), curing the bather layer.

14. The method as set forth in claim 9, wherein at step (B), residues of the barrier layer remain in the concave parts.

15. The method as set forth in claim 9, wherein at step (C), electrode wirings are formed in the concave parts simultaneously with forming the sensing electrodes, the electrode wirings being made of a metal and connected to the sensing electrodes.

16. The method as set forth in claim 9, wherein at step (B), the stamp has a flat shape or a circular shape.

17. The method as set forth in claim 9, wherein at step (C), the sensing electrodes are formed so as to be buried in the concave parts.
